(19) United States
(12) Patent Application Publication
(10) Pub. No.: US 2009/0112859 A1
(43) Pub. Date: Apr. 30, 2009

(54) CITATION-BASED INFORMATION RETRIEVAL SYSTEM AND METHOD

(76) Inventor: Peter J. Dehlinger, Palo Alto, CA (US)

Correspondence Address: King & Spalding LLP, P.O. Box 889, Belmont, CA, 94002-0889, US

(21) Appl. No.: 11/923,872

(22) Filed: Oct. 25, 2007

(51) Int. Cl. G06F 17/30

(52) U.S. Cl. 707/6; 707/E17.014

(57) ABSTRACT

Disclosed are a method, machine-readable code, and a system for matching one or more citation tags with citation-rich documents or with professionals who are associated with a group of citation tags. The method takes a user input that can be converted to one or more primary search tags, and accesses a matrix of pair-wise tag co-occurrence values that are related to the co-occurrence of each pair of tags extracted from documents contained in a collection of citation-rich documents, to identify, for each primary tag received those secondary tags whose pair-wise co-occurrence values with respect to the primary tag is above a selected threshold value. A tag search vector constructed from the secondary tags and optionally, the primary vectors, is used in a database search to identify those documents or professionals having the highest tag-matching score with respect to the tag search vector, and these results are then displayed to the user.

### FIELD OF THE INVENTION

The present invention relates to a system, method and machine-readable code for that uses citations extracted from citation-rich documents to identify and/or promote group professionals or identify citation-rich documents.

### BACKGROUND OF THE INVENTION

Internet searching and other information retrieval tools allow word-based information to be retrieved and otherwise manipulated in a variety of ways. For example, a user may be looking for a particular document or article of interest, or for a particular website of interest, or for the names of professionals in a given field, e.g., law or medicine.

Existing search methods are typically limited to key word searching in which a small number of key words or names are used to identify documents or professionals or websites containing those words or names. This type of searching may be laborious and/or hit-or-miss, in that many documents or other written information may need to be viewed before documents or other information of interest is located. Name searching, or course, requires that the user already know the names to be searched.

At a higher level of information retrieval, it would be desirable to make meaningful connections between already known or retrieved documents or other information and related documents, information or people. This might allow, for example a user who has tracked down one document of interest to find all other documents that are related by content, or might allow a user who has identified a certain area of expertise, to identify professionals associated with that expertise, for example, as a social network tool for finding people with similar professional interest. It is this general type of associative information retrieval that is addressed by the present invention.

### SUMMARY OF THE INVENTION

In one aspect, the method includes a computer-assisted method for matching one or more citation tags with citation-rich documents or with professionals who are associated with a group of citation tags. The method includes the steps of:

(a) receiving an input from a user that contains or can be converted to contain one or more primary search tags,

(b) accessing a matrix of pair-wise tag co-occurrence values that are related to the co-occurrence of each pair of tags extracted from documents contained in a collection of citation-rich documents, to identify, for each primary tag received in step (a) those secondary tags whose pair-wise co-occurrence values with respect to the primary tag is above a selected threshold value,

(c) constructing a tag search vector containing, as vector terms, a plurality of the secondary tags identified in step (b), where the vector term coefficients for secondary tags are related to their pair-wise co-occurrence values with respect to the associated primary tag,

(d) accessing a database that links citation tags to citation-rich documents or to professionals, thereby to identify those documents or professionals having the highest tag-matching score with respect to the tag search vector, and

(e) displaying to the user, information about one or more of the documents or professionals identified in step (d).

Step (c) may include constructing a tag search vector containing, as vector terms, for each such primary tag, those secondary tags associated with that primary tag whose pair-wise co-occurrence values with respect to the primary tag is above a selected threshold value.

Step (c) may include constructing a tag search vector containing, as vector terms, one or more of the primary tags received in step (a) and for each primary tag, those secondary tags associated with that primary tag whose pair-wise co-occurrence values with respect to the primary tag is above a selected threshold value.

The matrix accessed in step (b) may contain as its pair-wise co-occurrence values for any two tags, the ratio of number of documents containing both tags to the total number of documents containing either tag. Alternatively, the matrix accessed in step (b) may contain as its pair-wise tag co-occurrence values for any two tags, the conditional probability of finding one of the two tags, given the other of the two tags. The sum of the pair-wise co-occurrence values in each row of the matrix may be normalized to 1.

Where the user input is a statement of group of words representing a concept, step (a) may include the steps of: (a1) accessing a database containing phrases that represent summary holdings, statements, or conclusions contained in the collection of citation-rich documents, and for each such phrase, a tag representing the citation associated with that phrase in a citation-rich document, (a2) searching the database to identify one or more phrases that correspond to the user-input query, and (a3) accessing the database to link each of the one or more phrases identified in (a2) to associated citation tag(s) in the database. Step (a) in the method may further presenting to the user, word-weight choices that allow the user to select the coefficient that is assigned to each word in the query.

Where the user input includes one or more citation-rich documents, step (a) may include processing one or more input citation-rich documents to extract citation tags from the document, where the citation-rich documents are selected from the group consisting of published case law, legal briefs and opinions, and scholarly journal articles, and step (c) may include accessing the database that links citation tags to citation-rich documents.

For use in identifying professionals whose expertise match the one or more input primary search tags, step (d) may include accessing a database that links citation tags to professionals, thereby to identify those professionals having the highest tag-matching score with respect to the tag search vector, and step (e) includes displaying to the user, information about one or more of the professionals identified in step (d).

For use in contextual advertising of professional services that match the one or more input primary search tags, step (d) may include accessing a database that links citation tags to advertisements for services for professionals, thereby to identify those advertisements having the highest tag-matching score with respect to the tag search vector, and step (e) may include displaying to the user, one or more advertisements identified in step (d).

For use in identifying citation rich documents that match the one or more input primary search tags, step (d) may include accessing a database that links citation tags to citation-rich documents, thereby to identify those documents having the highest tag-matching score with respect to the tag search vector, and step (e) may include displaying to the user, one or more documents identified in step (d).

For use in identifying, promoting, or grouping one or more legal professionals having expertise with a given legal problem of interest, the citation-rich documents may be selected from appellate court decisions, legal briefs and memo, and law-review articles.

For use in identifying, promoting, or grouping one or more medical professionals having expertise with a given medical problem of interest, the citation-rich documents may include medical journal articles.

In another aspect, the invention includes machine-readable code which is operable on a computer to execute machine-readable instructions for performing the above method steps, for use in matching one or more citation tags with citation-rich documents or with professionals who are associated with a group of citation tags.

Also forming part of the invention is a website-based system for matching one or more citation tags with citation-rich documents or with professionals who are associated with a group of citation tags. The system includes (1) a website server accessible by user computer terminals, and (2) machine-readable code which is operable on the server to execute machine-readable instructions for performing the method steps described above.

These and other objects and features of the invention will become more fully apparent when the following detailed description of the invention is read in conjunction with the accompanying drawings.

### BRIEF DESCRIPTION OF THE DRAWINGS

FIG. 1 shows hardware and software components of the system of the invention;

FIG. 2 shows, in summary diagram form, the processing of citation-rich documents to form various database tables that may be employed in the invention;

FIG. 3 illustrates a tagged statement extracted from a citation-rich document.

FIGS. 4A-4E show representative table entries in a statement-ID table for citation-rich documents (4A), a statements word index table (4B), a tag-ID table (4C), a member ID table (4D), and an advertiser-ID table (4E);

FIG. 5 shows a portion of a tag co-occurrence table;

FIGS. 6A and 6B show in flow diagram form, operations in processing citation-rich documents to form a statement-ID table and tag-ID table (6A), and in assigning tag IDs (6B);

FIG. 7 is a flow diagram of steps used in generating a co-occurrence matrix;

FIG. 8 is a flow diagram showing steps in generating primary tags from a word query;

FIG. 9 shows steps in generating a tag search vector from either a word query or a document input;

FIG. 10 shows the logic for finding top-matching documents, members or advertisers in accordance with the invention;

FIGS. 11A-11C are plots of tag-match values for primary-(squares) and secondary-(circles) tag searches for citation-rich documents, where documents having similar legal issues as the parent search document are indicated by solid symbols;

FIGS. 12A-12D are graphical user interfaces for a website system in accordance with the invention, showing an initial GUI for finding legal propositions (12A), a display page for retrieved propositions (12B), a display page for cited statements for a selected case (12C), and a display page for related cases (12D); and

FIGS. 13A and 13B are graphical user interfaces for a website system in accordance with the invention, showing an initial GUI for finding legal expertise (13A) and a display page for retrieved legal experts (13B).

### DETAILED DESCRIPTION OF THE INVENTION

### A. Definitions

A “citation-rich document” is a document containing at least one and typically a plurality of cited references or citations, and associated statements. For example, a reported court case typically contains many cited cases, where each cited case (citation) is associated with a holding or summary of that case, usually a statement that precedes the case citation. Similarly, many types of legal documents prepared by lawyers, such as opinions, briefs, and legal memos, will contain a plurality of cited cases, along with the case holdings or summaries. A scientific or scholarly article will likewise contain a plurality of cited references, typically in footnote/bibliographic form, each citation typically being preceded by or included within a statement that summarizes the idea or conclusion of the cited reference.

A “statement” or “summary statement” refers to a summary of a holding or conclusion associated with a cited reference, or citation. The statement, as it occurs in a citation-rich document, is typically a complete sentence, and is followed by or includes a bibliographic citation, which may be a footnote or author citation or case-name citation to a bibliographic listing of cited references or cases, or may be the actual citation itself.

A “search query” or “query statement” or “user-input query” refers to a single sentence or sentence fragment or fragments or list of words and/or word groups that describe or are descriptive of the given problem or specialty for which expertise is being sought.

A “verb-root” word is a word or statement that has a verb root. Thus, the word “light” or “lights” (the noun), “light” (the adjective), “lightly” (the adverb) and various forms of “light” (the verb), such as light, lighted, lighting, lit, lights, to light, has been lighted, etc., are all verb-root words with the same verb root form “light,” where the verb root form selected is typically the present-tense singular (infinitive) form of the verb.

“Generic words” refers to words in a natural-language passage that are not descriptive of, or only non-specifically descriptive of, the subject matter of the passage. Examples include prepositions, conjunctions, pronouns, as well as certain nouns, verbs, adverbs, and adjectives that occur frequently in passages from many different fields. “Non-generic words” are those words in a passage remaining after generic words are removed.

A “document identifier” or “DID” identifies a particular digitally encoded or processed document in a database, in particular, a citation-rich document.

A “statement identifier” or “SID” identifies a particular summary statement, in particular, a statement extracted from a citation-rich document and associated with one or more citations. Typically, each statement extracted from a citation-rich document is assigned a separate identifier, so that identical statements extracted from different documents are assigned different SIDs, although they may have the same citation identifier or tag.

A “tag identifier” or “citation identifier” or “TID” identifies a particular tag, e.g., case cite or bibliographic reference extracted from a citation-rich document. In the case of tags from citation-rich documents, a tag identifier may be associated with one or more, and often several, different statement identifiers.

A “database” refers to a database of records or tables containing information about documents and/or other document- or citation-related information. A database typically includes two or more tables, each containing locators by which information in one table can be used to access information in another table or tables.

A “tagged statement” refers to a statement extracted from a citation-rich document and its associated citation, i.e., citation tag.

A “member” refers to a professional, or to a group of professionals, typically having a common affiliation, such as belonging to a common law firm or medical foundation. A member is typically displayed to a user by name, affiliation or institution, specialty, locale or jurisdiction, and contact information, such as address, phone and email address.

An “advertiser” refers to a professional or professional organization or institution that is displayed to a user as a professional solicitation or advertisement. A member may also be an advertiser.

A “professional” refers to a member or advertiser who has professional expertise and credentials in a professional field, such as medicine, law, science, engineering, economics or other professional and/or academic field in which proceedings or advances in the field are published in citation-rich documents.

### B. System Components

FIG. 1 shows the basic components of a system 20 for use in for matching one or more citation tags with citation-rich documents or with professionals who are associated with one or more citation tags. A computer or processor 24 in the system may be a personal computer or a central computer or server that communicates with a user's personal computer. The computer has an input device 22, such as a keyboard and mouse, by which the user can enter a query or other information, as will be described below. A display or monitor 26 displays the interface and program operation states and output. Computer 24 in the system is typically one of many user terminal computers, each of which communicates with a central server or processor 28 on which the main program activity in the system takes place.

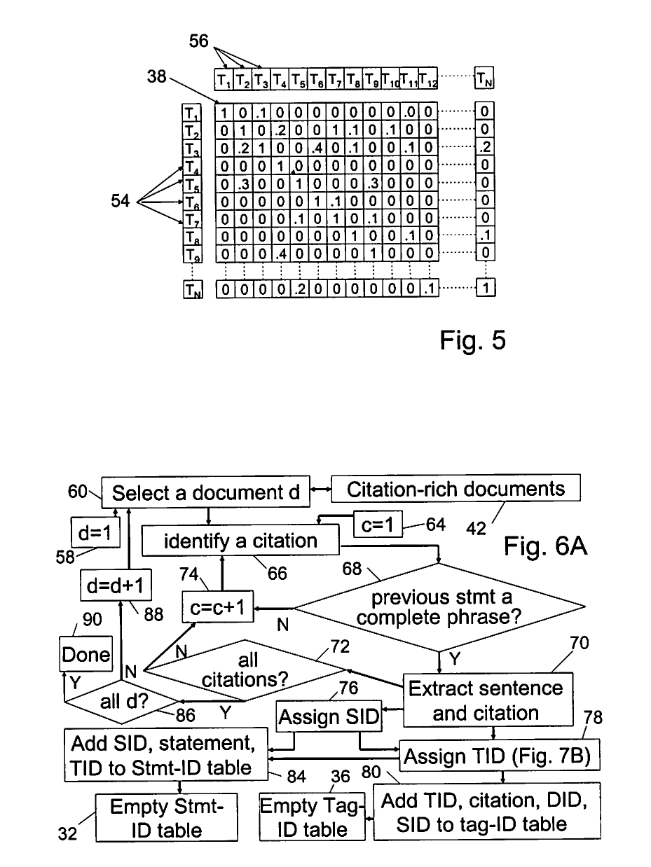

A database in the system, typically run on processor or server 28, includes in one embodiment a statement word-index table 30, a statement-ID table 32, a tag co-occurrence table or matrix 34, a tag-ID table 36, a member-ID table 38, and a advertiser-ID table 40, as will be described below, e.g., with reference to FIGS. 4A-4E, and FIG. 5. The database also includes a database tool that operates on the server to access and act on information contained in the database tables, in accordance with the program steps described below. One exemplary database tool is MySQL database tool, which can be accessed at www.mysql.com.

It will be appreciated that the assignment of various stored documents, databases, database tools and search modules, to be detailed below, to a user computer or a central server or central processing station is made on the basis of computer storage capacity and speed of operations, but may be modified without altering the basic functions and operations to be described.

### C. Basic Database Tables and Data Relationships

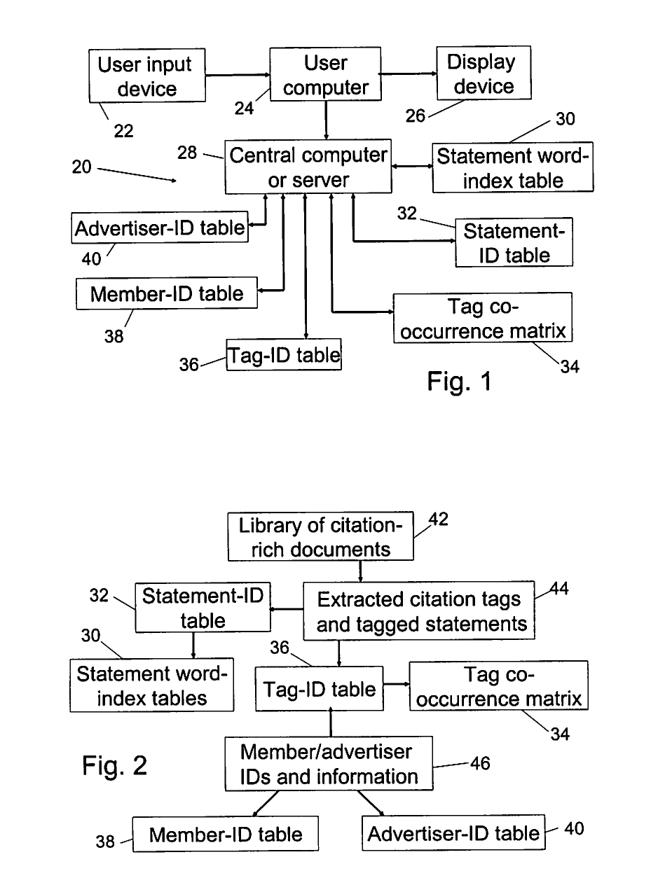

FIG. 2 is a flow diagram of the high-level steps used in processing a library of citation-rich documents 42. Collectively, the citation-rich documents includes a library of documents that may contain up to several hundred to several hundred thousand or more documents, such as a large collection of scientific or scholarly publications, reported legal cases, e.g., appellate cases, all of which contain multiple citations or cites, e.g., references to other cases or other articles or scholarly works. One exemplary library of citation-rich documents used for creating a “legal” database are reported appellate decisions, e.g., from both federal and state appellate courts. An exemplary library of citation-rich documents used for creating a “medical” or “technical” database are articles from biomedical or technical journals or periodicals.

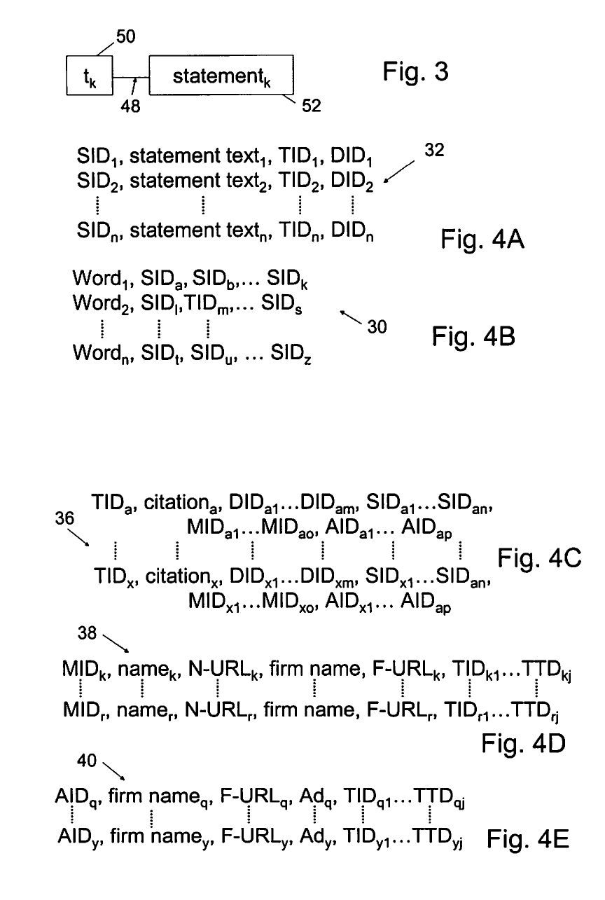

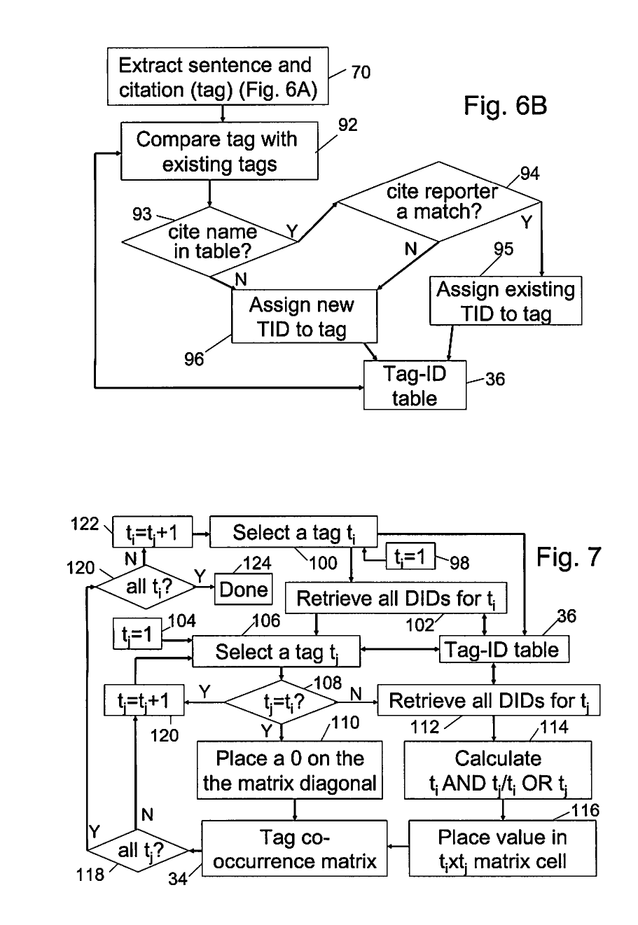

Each document is processed to extract citation tags and associated statements, at 44, yielding typically a plurality, e.g., 3-30 of tagged statements. FIGS. 6A and 6B below describe steps for extracting the citations (or cites) from each document, and the typically one summary statement (also referred to herein as a “holding” or “summary” or “proposition”) that the cite “stands for” in that particular document, yielding a plurality of tagged statements 48 in FIG. 3, each including a summary statement 52 and one or more citations or citation tags 50. Each statement extracted from a document (and associated with one or more citation tags) is placed in statement-ID table 32, which has as its key locator, a statement identifier (SIDᵢ), where each statement is assigned a separate identifier. That is, identical statements from the same or different documents are assigned different statement identifiers, and the program need not attempt to consolidate identical or near-identical statements into a single statement.

FIG. 4A shows typical entries for table 32, and includes for each SIDᵢ locator, the text of the extracted statement, a tag (citation) identifier (TIDⱼ) that identifies the citation tag or tags associated with that statement (the citation identifier is assigned as described below with reference to FIG. 6B), and a document identifier (DIDᵢ) that identifies the document from which the statement and associated tag have been extracted. Typically a document will contain several TIDs. The statements associated with any given TID may be identical, similar in wording and/or content, or different in content, so that any particular TID may “stand for” more than one holding or proposition. In addition to the table information indicated, the statement-ID table may include, for each statement, the full text of a document passage, e.g., paragraph, containing that statement.

The statements in the statement-ID table are processed, in accordance with the previously described methods, for example, as described in co-owned U.S. published patent application 20060149720, which is incorporated herein by reference, to generate the statement word-index table. The key locator for the word-index table is a statement word, such as Wordᵢ shown in FIG. 4B, and for each word, there is a list of all SIDs containing that word, and for each statement SID, the table may optionally include the TID(s) associated with that statement (not shown). Most words in the table will contain a relatively long list of SIDs and associated TIDs. Preferably, the words in the table do not include generic words, such as common pronouns, conjunctions, prepositions, etc., and may also exclude as certain generic words that are common to a large number of statements, such as (in the legal field) “legal,” “law,” “standard,” “test,” “court,” and the like, and (in the scientific field), such words as “study,” “experiment,” “finding,” “results,” “conclusion,” and “data,” and the like. The TID associated with each SID in the word-records table is assigned in accordance with the steps described with respect to FIG. 6B.

Also as shown in FIG. 2, the citations from the citation-rich documents are assembled into tag-ID table 36 which has the table information shown in FIG. 4C. The locator in this table is a tag ID (TIDᵢ), and each row in the table includes the full citation for that TID, for example, a listing of the author, title, journal name, volume, page number and year for a journal article, or case name, reporter name, volume, and page number, and court and year information, volume for a legal citation, the document identifiers (DIDs) from which the tags are derived, and the statement identifiers SIDs for all statements associated with that TID. In addition, each TIDᵢ row includes member identifiers (MIDs) and advertiser identifiers (AIDs) that are linked to the TIDs as discussed below.

With continued reference to FIG. 2, tag-ID table 36 is used in creating tag co-occurrence matrix 34. The co-occurrence matrix, a portion of which is shown below in FIG. 5, is an N×N matrix of N row tags 54 times N column tags 56, where the value of each matrix entry for a tᵢ×tⱼ matrix pair is related to the number of times the two tags (citations) tᵢ and tⱼ co-occur, i.e., are present in the same document. The sum of the values in each row may be normalized to a common value, e.g., such that the sum of all matrix values in a given row is 1. The matrix is formed in accordance with the method described with respect to FIG. 7.

Also as shown in FIG. 2, professional member and advertiser information, such as member/advertiser names, institutions or affiliations, contact information, and documents and/or particular tags that the members/advertisers are associated with, is placed in separate tables 38, 40, respectively. Each group-member identifier MIDᵢ (the locator in table 38) associated with a tag in table 36 contains information, such as shown in FIG. 4D, that can include member name, email link (N-URL), name of institution or affiliation, email link to the institution (F-URL), and individual citation TIDs associated with the member. The TIDs may be supplied in the form of citation-rich documents representing the member's professional expertise, e.g., citation-rich documents with which the member authored, co-authored, or was otherwise intimately involved in, or may be supplied directly as citation tags, for example, representing a professional's published papers, or case-law cites representing legal cases with which the professional was involved. Where the member information includes citation-rich documents, these are processed, as above, to extract all citations in the documents or all citations associated with tagged statements. The member information may be supplied by the individual group members, e.g., by entry in an on-line personal information form.

Similarly, in constructing table 40, each advertiser identifier AIDᵢ (the locator in table 40) associated with a tag in table 36 contains information, such as shown in FIG. 4E, that can include name of institution or affiliation, email link to the institution (F-URL), the identifier for a contextual advertisement (Ad), and TIDs associated with that advertiser, supplied by the advertiser either in the form of citation-rich documents or directly as citation tags.

Thus, in system operations involving retrieval of specific tags for purposes of identifying professional expertise or for contextual advertising related to the tags, the citation tags retrieved from the tag-ID table are matched to associated members or advertisers in tables 38 or 40, respectiviely, and specific information/ads associated with the identified MID or AID are then displayed to the user.

Although not shown, both the member-ID and advertiser-ID tables may additionally include locale identifiers (in addition to URLs), such as city/state names or zip codes, that identify the particular office or region of practice of the member or advertiser, so that members may be matched to user locale and ads can be directed to local users.

### D. Processing Documents and Constructing the System Tables

FIG. 6A is a flow diagram of steps employed by the system in extracting citations and associated statements from each of a plurality, i.e., collection or library, of citation-rich documents 42. For purposes of illustration, documents 42 are legal documents, either opinions, briefs or other documents generated by lawyers, or case-law decisions, e.g., appellate decisions published by court reporters. It will be appreciated from the following description how the system can be modified for extracting citations and statements from other types of citation-rich documents, such as scientific or other scholarly works, or any other type of documents in which statements in the document are supported by reference citations. In particular, it is noted that in most citation-rich legal documents, the citation is often given in full within the body of the document, whereas in many other types of citation-rich documents, the full citation is given as a footnote or in a bibliographic list of references at the end of the document.

The total number of documents to be processed may be quite large, e.g., up to several hundred thousand citation-rich documents or more. Each document, as it is selected at 60 (with the counter initialized at 1 for the first document, at 58) is assigned a new, next-up document ID, which will follow the document through the construction of the database tables.

For purposes of specific illustration, it is assumed that the document being processed is a patent-validity opinion, and that the particular passages the program first encounters are those Paragraphs 1-4 below, which will be used to illustrate the operation of the system in extracting citations and their corresponding statements:
[Paragraph 1] The presumption of validity of patent claims, like all legal presumptions, is a procedural device, not substantive law. However, it does require the decision maker to employ a decisional approach that starts with acceptance of the patent claims as valid and that looks to the challenger for proof of the contrary. Accordingly, the party asserting invalidity has not only the procedural burden of proceeding first and establishing a prima facie case, but the burden of persuasion on the merits remains with that party until final decision. TP Laboratories, Inc. v. Professional Positioners, Inc., 724 F.2d 965, 971, 220 USPQ 577, 582 (Fed. Cir. 1984); Richdel, Inc. v. Sunspool Corp., 714 F.2d 1573, 1579, 219 USPQ 8 (Fed. Cir. 1983).
[Paragraph 2] The challenging party's burden also includes overcoming deference to the PTO's findings and decisions in prosecuting the patent application. Deference to the PTO is due “when no prior art other than that which was considered by the PTO examiner is relied on by the attacker.” American Hoist & Derrick Co. v. Sowa & Sons, 725 F.2d 1350, 1359 (Fed. Cir.), cert. denied, 469 U.S. 821, 83 L. Ed. 2d41, 205 S. Ct. 95 (1984). Conversely, no such deference is due when the party challenging the patent raises prior art or evidence that was not considered by the PTO in its decision and evaluation of the patent application:
[Paragraph 3] When an attacker simply goes over the same ground traveled by the PTO, part of the burden is to show that the PTO was wrong in its decision to grant the patent. When new evidence touching validity of the patent not considered by the PTO is relied on, the tribunal considering it is not faced with having to disagree with the PTO or with deferring to its judgment or with taking its expertise into account. American Hoist, at 1360.
[Paragraph 4] The description must clearly allow persons of ordinary skill in the art to recognize that the inventor invented what is claimed.” Thus, an applicant complies with the written description requirement “by describing the invention, with all its claimed limitations, not that which makes it obvious,” and by using “such descriptive means as words, structures, figures, diagrams, formulas, etc., that set forth the claimed invention.” Lockwood, supra.

The first step in the document processing is to identify a citation, at 66, with a citation counter 64 initialized to 1. This is done, in the case of legal citations, by the program looking for certain words, abbreviations, and indicia that are common to legal citations. For example, the program might look for one of the following cues characteristic of a legal case name: “In re,” “ex parte,” or “v.” In addition, the program might look for the abbreviation for a state or federal reporter, such as “F.2d,” “F.Supp,” or “SCt,” or “USPQ”, all of which can be entered into a relatively small library of case reporters at the state and/or federal level. If a reporter name is found, the program could confirm by looking for numbers on either side of the reporter abbreviation. Finally, the case citation is likely to include the name of the trial or appellate court which handed down the decision, and the program can further confirm a citation by identifying a court abbreviation, such as “SCt,” “NDCa,” “Fed. Cir.” and so forth, followed by a year, e.g., “1999,”, “2004.” indicating the year that the decision was published.

A similar approach for identifying citations would apply, for example, to citation-rich scientific or technical publications, where the citation would be identified on the basis of one or more of (i) a standard abbreviation for each of a plurality of journals that are likely to be encountered (stored in a small dictionary); (ii) standard journal identifier information, such as volume, page and date, and (iii) a list of authors, last name, followed by an initial, and usually at the beginning of the citation. It is recognized that the citations in many scientific, technical, and law-journal articles are contained in an end-of document bibliography which is referred to within the text either by a reference number, typically in parentheses or brackets, or by first author name, which thus provides a cue to find the full citation as a footnote or in a bibliography at the end of the document.

In the example given above, the two citations in Paragraph 1 can each be identified by (i) a case name containing a “v.” (ii) the names of court reporters “F.2d” and “USPQ2d,”, (iii) a number preceding and following each court reporter, and (iv) a court name abbreviation and year of publication (typically in parentheses). The end of the first cite and beginning of the second one can be identified by one or all of (i) a semi-colon at the end of the first cite; (ii) the court name abbreviation and year at the end of the first cite, and (iii) a new case name at the beginning of the second cite. TP Laboratories, Inc. v. Professional Positioners, Inc., 724 F.2d 965, 971, 220 USPQ 577, 582 (Fed. Cir. 1984); Richdel, Inc. v. Sunspool Corp., 714 F.2d 1573, 1579, 219 USPQ 8 (Fed. Cir. 1983).

Similarly, the sole cite in Paragraph 2 is identified by (i) a case name containing a “v.” (ii) the name of a court reporter “F.2d”, (iii) a number preceding and following each court reporter, and (iv) a court name abbreviation and year of publication (typically in parentheses. In addition, the subsequent appeals history of the case may follow the initial cite, this being distinguished from a separate citation by one or more of (i) lack of a semi-colon, (ii) lack of a new case name, and (iii) an abbreviation of the disposition of the appeal, e.g., “cert denied.” As above, the latter abbreviation is included in a “case-citation” abbreviations library that the program accesses during the operation of locating citations.

“American Hoist & Derrick Co. v. Sowa & Sons”, 725 F.2d 1350, 1359 (Fed. Cir.), cert. denied, 469 U.S. 821, 83 L. Ed. 2d41, 205 S. Ct. 95 (1984).

It is common in a citation-rich document for reference to be made to a previously-referenced citation, and in this case, the citation may include simply a name in the case name followed by a comma the abbreviation of “supra,” meaning “above,” or “higher up” (in the document), “infra,” meaning “below” (in the document) or “ibid,” meaning “in the same passage or citation,” or alternatively, a name in the case, followed by a comma, and the word “at” followed by a page number, referring to the page in the citation at which the referenced statement is found.

For example in Paragraph 3, the citation to “American Hoist, at 1360” is recognized by (i) a name in a case name already cited in the document, and (ii) “at” followed by a number. Similarly, the citation in the Paragraph 4 “Lockwood, supra” is identified by (i) a name in a case name already cited in the document, and (ii) a comma followed by the word “supra.” Of course, identifying previously cited references in any document requires that the program keep a list of cited case names during the processing of each documents, so that these can be compared with case-name abbreviations when one of the indicia of a previously cited case is encountered. Once a citation is encountered, it is extracted and placed in a file where the citation will be assigned a TID, as described below with respect to FIG. 6B.

As shown at 68 in FIG. 6A, the program then considers the sentence that immediately precedes the citation. If the sentence is a complete sentence, i.e., begins with a capital letter and ends with a period or semi-colon or with a parentheses which give the citation, the sentence is extracted and assigned to the “statement” for the citation or citations that it precedes, as a 70. Thus, for example, in Paragraph 1, the complete sentence that precedes each of the two citations is: Accordingly, the party asserting invalidity has not only the procedural burden of proceeding first and establishing a prima facie case, but the burden of persuasion on the merits remains with that party until final decision.

Similarly, the sentence that precedes the single citation in Paragraph 2 is: Deference to the PTO is due “when no prior art other than that which was considered by the PTO examiner is relied on by the attacker.”

This preceding sentence is the statement or holding (or one of the statements or holdings) that will be assigned to the associated citation for the particular document from which the statements is extracted. As indicated at 70 in the figure, the sentence (statement) and associated citation are extracted, and the statement is assigned a statement ID number at 76 (each statement is assigned a new, next-up number) and the statement ID (table locator), statement text, and DID is added to statement-ID table 32, at 84. Once the TID has been identified, as described below with respect to FIG. 6B, and indicated at 78 in FIG. 6A, it is added to table 36. If the TID assigned at 78 is a new TID, it is added at 80 to table 36, along with the associated citation, SID, and DID. If the TID is assigned an already-existing TID, the new SID and DID information is added to the information in the existing TID row, as can be appreciated from FIG. 4C.

If, during the processing of text that precedes a citation, an incomplete sentence is encountered, e.g., because a citation occurs in the middle of the statement, the partial sentence back to the beginning of the sentence may be used as the citation statement, or the entire statement may be omitted, by advancing to the next citation without processing the tag associated with an incomplete sentence, as indicated. If the statement contains two or more citations, each citation is assigned to the entire statement. In some case, the case name will precede the associated statement. This format can be recognized typically by the words “In” or “according to” or “as stated in” (name of case), followed by the associated statement. Typically, where the text preceding an identified citation is not a complete sentence, the program advances to the next identified citation, through the logic of 68, 74.

The above text processing is continued, through the logic of 72, 74, until all citations in a document and associated statements have been identified, and all SIDs, associated statement texts, TIDs, associated citations, DID, and other identifying information has been placed in the appropriate tables. Each document is similarly processed through the logic of 86, 88, until all of the citation-rich documents in 62 have been so processed.

FIG. 6B is a flow diagram of the operation of the program in assigning new TIDs to each newly-extracted citation. Illustrating the procedure for legal citation-rich documents, after extracting a new citation and its statement, at 70, and as described above, the new tag is compared at 92 with existing tags in tag-ID table 36. This comparing entails comparing each name in the new citation with each name in existing citations in table 36. If a name match is found in any citation, at 93, the program compares the reporter information between the new and searched citation. If a reporter-information match is found, at 94, e.g., identical reporter and adjacent numbers, the two citation tags are considered identical. In this case, the just-extracted tag is assigned the number of the already-assigned tag, at 95, and that tag number is assigned to the various database tables. In particular, and as shown in the figure, the document ID from which the citation was extracted is added to the list of existing DIDs for that assigned TID in the tag-ID-table. If the newly-extracted tag is not already in the tag-ID table, from the comparison at 93, 94, the tag is assigned a new number, at 96, and placed as a new citation entry in the citation-ID table, and also added to the other database tables.

Where the tagged statements in a citation-rich document are footnotes, the program notes each footnote, accesses the footnote information, and asks: Is the footnote a reference citation? This question is answered, as above, by checking for citation information, such as known journal abbreviations, and/or other standard citation indicia, such as volume, page, date, and author indicia. If the footnote is confirmed as a citation, the sentence associated with the footnote is stored as a citation, and given the assigned citation.

Alternatively, the citation format may be a parenthetical entry containing an author name or names, typically followed by the year of publication. In this format, when a single or small number of names in parenthesis is found, the program checks the bibliography at the end of the document, and looks for that name among the listed authors, which typically appears as at the beginning of the citation. If a citation is found, the sentence associated with that citation is then stored as a tagged statement.

Where other citation formats are used, one simply modifies the tagged-statement extraction program so that (i) each occurrence (notation) of a citation is noted, (ii) the program retrieves the actual citation from the document, and (iii) that citation is associated with the associated statement in the document.

The types and variations of statements extracted from citation-rich documents can be seen in the example below, and by accessing the legal-search website at www.lexcites.com. The tagged statements in the website include tagged statements from the cases in the Supreme Court Reporter, 1986-present, in which 15,748 tagged statements were extracted from 2,386 cases, the 9th Circuit (F.2d and F.3d), 1996-present, in which 46,683 tagged statements were extracted from 4886 cases, and CAFC cases (F.2d and F.3d), 1995-present, in which 11,499 tagged statements were extracted from 2191 cases. In general, many of the statements associated with a given citation tend to be similar in meaning, particularly where the number of documents containing a citation is relatively small, e.g., less than about 5. However, with citations that are found in a large number of documents, e.g., 10-50 or more, a fairly wide variation in the content of the statements was observed.

FIG. 7 is a flow diagram of steps employed in the system for generating co-occurrence matrix 34. As noted above, this is an N×N matrix of all N tags tᵢ, where each tᵢ×tⱼ term in the matrix represents the number occurrence of documents in the system (e.g., citation-rich documents) that contain both TIDᵢ and TIDⱼ. To construct the matrix, tᵢ (the first tag) is initialized to i=1, at 98, and the program selects tag t₁ from the tag-ID table 36, at 100, and retrieves all of the DIDs for that TID, at 102. A second tag count at 104 is set at j=1 for tags tⱼ, and a second tag tⱼ is selected from table 36, at 106. If tⱼ is the same as tᵢ, the program advances to the next tⱼ, through the logic of 108, 120, and a zero is placed at the tᵢ×tᵢ matrix position (on the matrix diagonal) at 110. If tᵢ and tⱼ are different cites, the program retrieves all documents for tⱼ, at 112, from tag-ID table 36, and then calculates the number of documents containing both tᵢ and tⱼ divided by the number of documents containing either tᵢ or tⱼ, i.e., tᵢ AND tⱼ/tᵢ OR tⱼ. The calculated number is the probability of finding both tags in documents containing either tag. Alternatively, the program may calculate the conditional probability of finding tⱼ, given tᵢ, expressed as P(tⱼ|tᵢ) and calculated as P(tⱼ∩tᵢ)/P(tᵢ), or calculate some other value that represents the co-occurrence of both tᵢ and tⱼ in the same document. The calculated co-occurrence value is placed in the tᵢ×tⱼ matrix cell of matrix 34, as indicated at 116.

This process is repeated, through the logic of 118, 120 until all tᵢ×tⱼ co-occurrence values have been determined for the selected tag tᵢ. The program now proceeds to the next tag tᵢ+1, through the logic of 120, 122 until the matrix values for all t tags have been determined, at 124. The matrix values for each matrix row may be normalized to a sum of 1, as indicated above, or used without normalization.

E. Generating Tag Search Vectors from a User Input

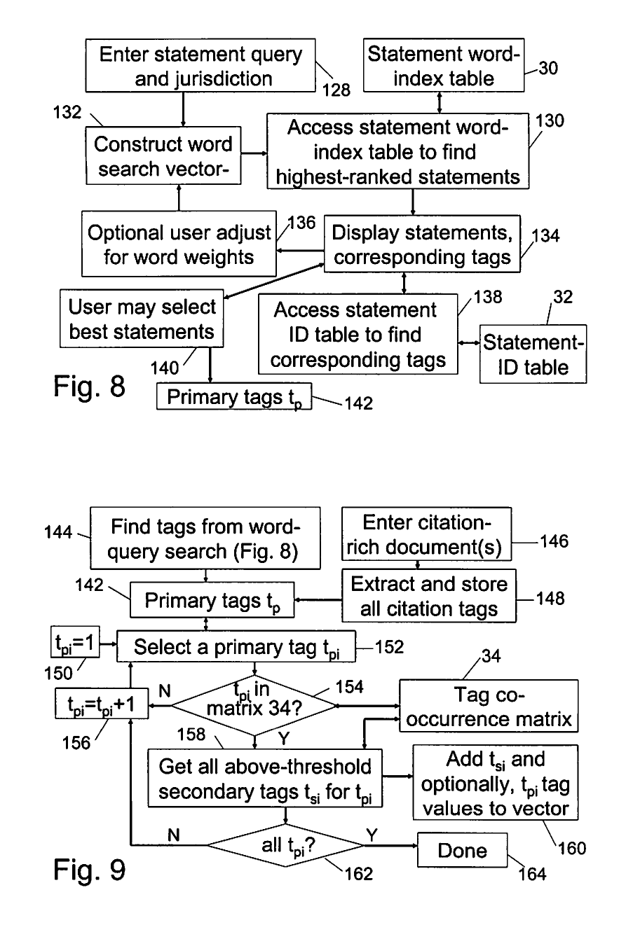

The method of the invention involves, as a first step, receiving one or more primary citation tags from a user input. These tags may be received by the user input in a variety of ways, as will now be discussed. In the method steps shown in FIG. 8, a user is searching for a particular statement, in this case, a legal proposition extracted from a case in a specified jurisdiction, e.g., Supreme Court, or Ninth Circuit, as indicated at 128, and as illustrated below. As indicated at 132, the input query words are used in forming a search vector, and the statement word index table 30 is accessed, at 130, to find the top-matching statements and corresponding citation tags, as detailed, for example, in the above-cited co-owned U.S. published patent application 20060149720. The program accesses statement ID-table 32, at 138, to find the corresponding tag(s) for each of the retrieved statements, and the statements and their tags are displayed to the user at 134.

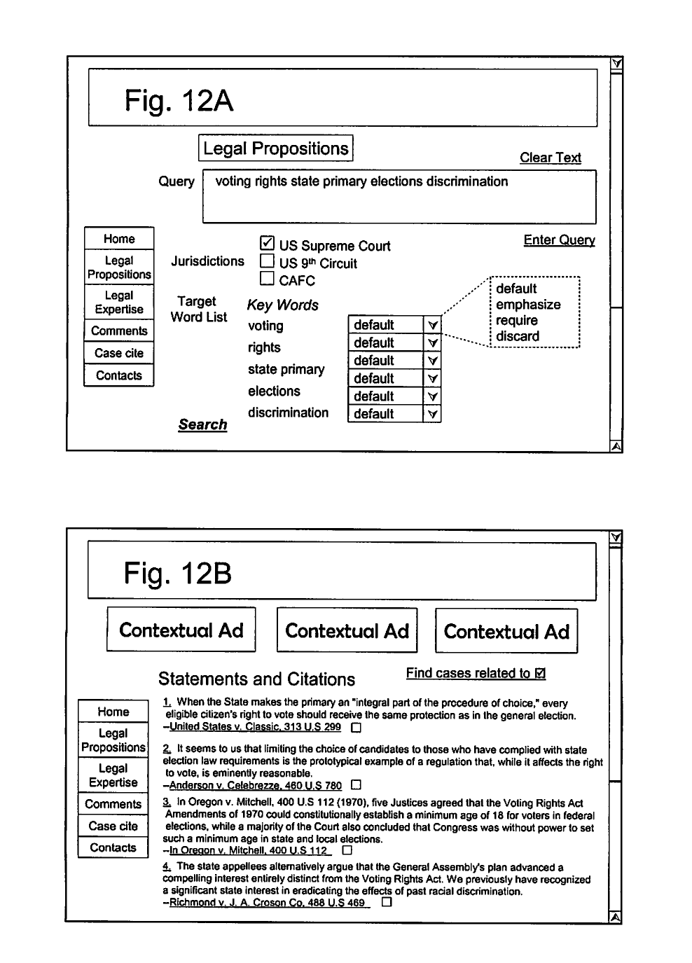

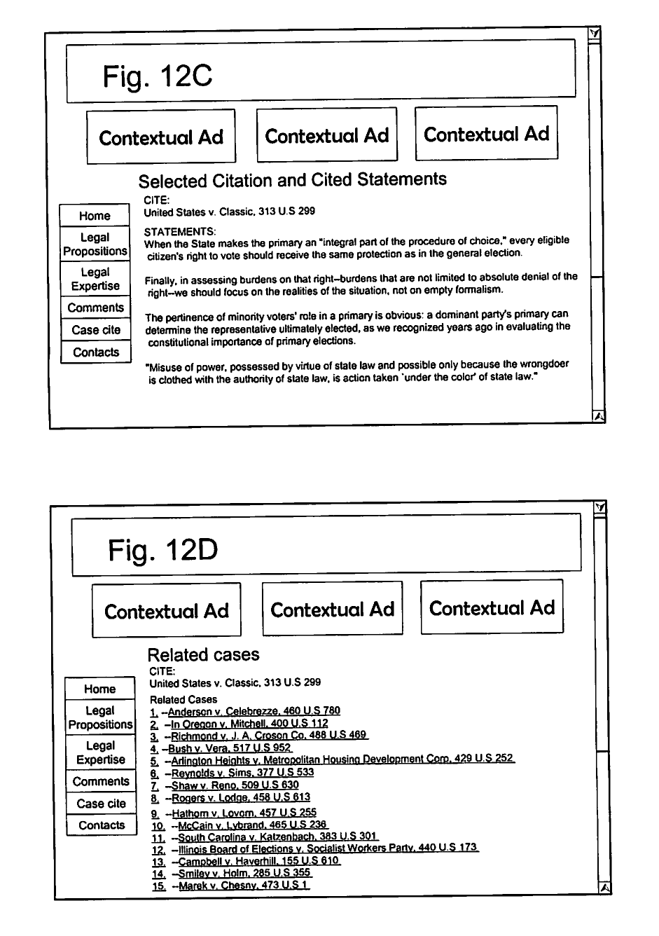

In one embodiment, the system allows the user to adjust the relative weights assigned to the words in the word search vector, e.g., to a default value of 1, and “emphasize” value of 5, a “require” value of 50, or a “discard” value of zero, by a pull-down menu associated with each word, and containing the choices “default,”, “emphasize,” “require,” and “discard,” as seen in the search cite ww.lexcites.com noted above, and as described below with reference to FIG. 12A. This feature is indicated at 136 in FIG. 8 and may be carried out before or after the initial statement-search operation. From the displayed statements, the user may select the best statements, or the system may simply select the N top-ranked statements, at 140, e.g., the top ten statements. The primary tags tₚ received at 142 are the citation tags corresponding to the selected statements.

Alternatively, and with reference to FIG. 9, the user may input a selected citation-rich document, e.g., legal appellate decision, at 146, and the program reads this document, as described above, to extract the document citations, at 148, either all separate citations or all citations associated with a tagged statement, to yield a group of one or more primary tags tₚ, at 142. Alternatively, the user may simply input one or more known citations as the primary tags tₚ.

To construct the tag search vector, and with reference to FIG. 9, the program selects a first primary tag tₚᵢ, at 152, with the primary tags initialized to i=1, at 150, and accesses the tag co-occurrence matrix 34 to determine if the selected primary tag tₚᵢ is in the matrix, at 154. If it is not, the program advances to the next primary tag, through the logic of 154, 156. If the tag is in matrix 34, the program retrieves the tags and associated co-occurrence values for all tags tₛᵢ, tₛⱼ, . . . tₛₙ in the tₚᵢ row in the matrix having values above a pre-selected threshold, at 158. This threshold may be zero, or some positive value that, depending on the range of co-occurrence values in a matrix row, will separate more statistically meaningful co-occurrence values from less meaningful ones. Thus, for example, the threshold may be set to include tags whose co-occurrence values are at least 25% of the highest co-occurrence value for that matrix row.

Thus, the data retrieved from the co-occurrence matrix, for a given primary tag tₚᵢ, is the tag identify and co-occurrence value of each tag tₛᵢ, tₛⱼ, . . . tₛₙ in the tₚᵢ matrix row having an above-threshold co-occurrence value. The tags thus retrieved are identified as secondary tags tₛ, and the tₛᵢ, tₛⱼ, . . . tₛₙ terms corresponding to the tₚᵢ primary tag are used in constructing the tag-search vector, as indicated at 160, and described further below. This process is repeated, for all tₚᵢ, through the logic 162, 158, until secondary tags values for all of the primary tags have been retrieved, which completes the process, at 164. As an example, if the primary tag is t₃ in FIG. 5, and the co-occurrence value threshold is 0.1, the program would retrieve t₂ (0.1), t₆ (0.4), t₈ (0.1), and t₁₁ (0.1), and the co-occurrence values would be stored for determining secondary-tag coefficients.

The search tag vector is constructed to include at least secondary tag terms, and may also be constructed to contain primary tag terms, as will now be considered. In either case, the resulting search vector is referred to as a secondary-tag search vector, distinguishing it from a primary-tag search vector that contains only primary tag terms. In one embodiment, only secondary tags are included in the vector. In this embodiment, the vector terms are all of the secondary tags tₛᵢ, tₛⱼ, . . . tₛₙ; tₛⱼ, tₛₖ, . . . tₛₚ; . . . tₛₙ, tₛₒ, . . . tₛₓ corresponding to primary tags tₚᵢ, tₚⱼ, . . . tₚₙ, respectively, that contain above-threshold co-occurrence values, and the coefficient assigned to each secondary-tag term is the sum of all co-occurrence values for that secondary tag term. Thus, if a particular secondary tag tₛₖ has above-threshold co-occurrence values for four different primary tags, the vector coefficient for that term is the sum of the four co-occurrence values. The final vector takes the form: V=cᵢtₛᵢ+cₖtₛₖ+ . . . cₓtₛₓ, where tₛᵢ is the ith secondary tag, and cᵢ is the coefficient for that tag term. Where the primary tag is also included in the vector, the system may be set to assign an arbitrary coefficient to each primary vector, e.g., a value that is 1× to 10× the greatest matrix co-occurrence value for a secondary tag associated with the primary tag.

### F. Identifying Top-Ranked Documents, Members or Advertisers

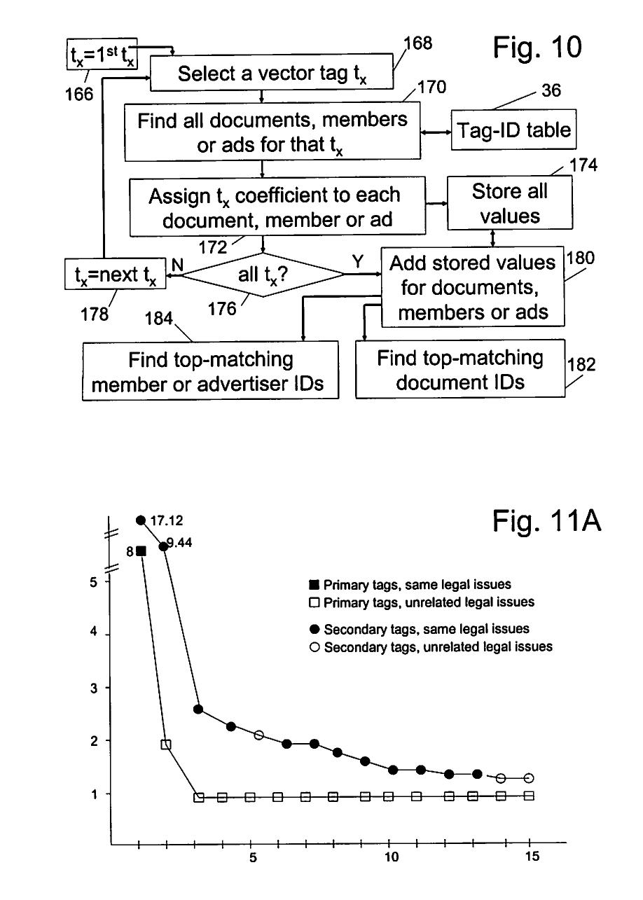

The secondary-tag search vector constructed as detailed in Section E is now applied to the tag-ID table, i.e., the tag-ID table is accessed, to identify those citation-rich documents or professionals (members and/or advertisers) having the highest tag-matching score with respect to the secondary-tag search vector. With reference to FIG. 10, and with the system initialized to consider the first tag vector term, at 166, the program selects this tag, at 166, then accesses tag-ID table 36 to identify all documents, members, and/or advertisers to be displayed to the user, according to user input (in the case of documents or members) or for purposes of contextual advertising (in the case of advertisers).

Once the list of DIDs, MIDs and/or AIDs for tag tₓ have been retrieved, each identifier is assigned the coefficient cₓ of tₓ in the search vector, at 172, and these values (the identifier and the assigned cₓ coefficient) are stored at 174 for later computation. The program then proceeds to the next tag tₓ in the search vector, through the logic of 176, 178, and repeats the above steps for the next tag in the search vector, until all tags in the search vector have been considered. The program now adds the stored DID, MID, and/or AID coefficient values for each identifier (the sum of the coefficients assigned to each identifier), at 180, to find the top-matching document IDs, at 182, or the top-matching member or advertiser IDs, at 184. The top-ranked documents or members are now displayed to the user, and/or contextual advertisements corresponding to the top-ranked AIDs are displayed, where the display information for members and ads is retrieved from tables 38, 40, respectively. It will be recognized in the case of MIDs or AIDs, the top-ranked identifiers may be further screened, e.g., for locale, so that only the top-ranked members in the user's locale are displayed, or only ads pertinent to the user's locale are displayed.

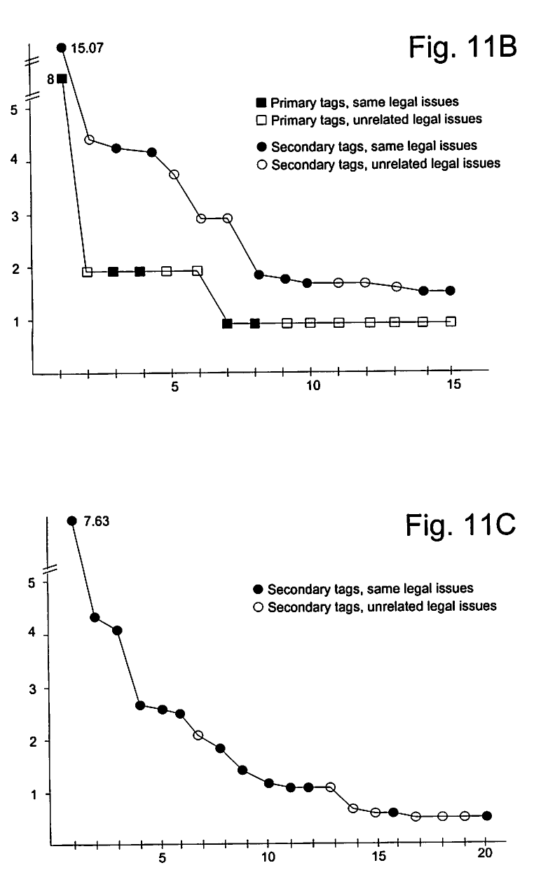

FIGS. 11A-11C demonstrate results of the method of the invention as applied to finding case-law cases that are related, in terms of legal issues, to a given (target) legal appellate law. In the first example, the “query” case law is Hendler v. U.S, 952 F.2d 1364 (Fed. Cir. 1991), a CAFC case involving a suit by a landowner against the U.S. government for inverse condemnation. The case thus involves issues of eminent domain and unfair taking of real property by the U.S. government.

The tag-ID table that was searched in this example was constructed from tagged statements extracted from a collection of CAFC cases, 1995-present, in which 11,499 tagged statements were extracted from 2191 cases. Co-occurrence values for the tag pairs were determined as the ratio of tᵢ AND tⱼ/tᵢ OR tⱼ, as above, the diagonal values were set to zero, and the values were unnormalized. A primary-tag search vector was constructed from the 8 primary tags extracted from the Hendler case, with each tag being assigned a value or 1. A secondary-tag search vector was constructed from above-threshold secondary tags for each of the 8 primary tags, where each tag term in the vector was assigned a coefficient value representing the sum of co-occurrence values for that tag among the 8 groups of secondary tags.

For each search vector, cases corresponding to the top 15 match score were identified, and the general subject of each of the cases was assessed. A case was deemed to be pertinent to the query Hendler case if it included the issue of government taking of land or other property under eminent domain. The results of the search, plotting tag-match score against case number, are shown in FIG. 11A. As seen, the primary-tag search vector identified only one case other than the Hendler case (the top-ranked case) that had a match value greater than 1. By contrast, the results for the secondary-tag search showed a meaningful match score ranking among the top-ranked cases. More significantly, the secondary-tag search retrieved 11 out of 14 cases that were pertinent to Hendler case (solid circles) whereas, the primary search retrieved no pertinent cases beyond Hendler itself.

A similar type of search was carried out for the query case Ethicon Endo-Surgery, Inc. v. U.S. Surgical. Corp., 149 F.3d 1309, 1315 (Fed. Cir. 1998), a CAFC case involving issues of misjoinder of inventorship as a defense to a patent infringement action. The primary search vector contained 8 primary tags from the Ethicon case, and the secondary search vector was constructed, as above, from secondary tags corresponding to the 8 primary tags, using the same tag-ID table as in the first example. A case was scored as pertinent is it dealt with issues of misjoinder of inventors and consequent effect of patent rights, e.g., as a defense to non-infringement.

FIG. 11B shows a plot of match scores for the top 15 cases, including the top-ranked Ethicon case. As above, the secondary search gave a much more meaningful basis for scoring the cases, and 7 pertinent cases (solid circles), versus 4 pertinent cases for the primary search (solid squares).

To further demonstrate the advantages of secondary-tag searching, as a means of linking a field of interest to related documents and/or professionals with the same professional interest, a search carried out with a single primary tag was used in locating pertinent cases. In this example, the query case was Thornburg v. Gingles, 478 U.S. 30 (1986), a U.S. Supreme Court case in which a state redistricting plan was challenged on the basis that it impaired the rights of the plaintiff minorities under the Voting Rights Act. A single tag extracted from the case was used to generate a secondary-tag vector, as above; the tag-ID table was constructed from 15,748 tagged statements extracted from 2,386 Supreme Court cases, 1986-present; and the co-occurrence matrix was constructed as above. A case was scored as pertinent if it dealt with a cause of action involving a discriminatory voting practice.

The search results are shown in FIG. 11C, plotting tag-match values over 20 top-ranked hits. Interestingly, the Thornburg case was not the highest-ranked case (it was #12 in rank), indicating that this case had fewer secondary tags related to the primary tag than 11 cases with higher ranking. The results show a meaningful ranking in cases over at least the top 15 cases, and a high percentage of pertinent voting-rights cases (12 out of 19).

The methods illustrated above demonstrate the ability of the search method to identify pertinent citation-rich documents, in this case, legal appellate decisions. In essence, one or more primary tags of interest are used to generate a secondary-search vector, which is then used to find documents containing the secondary tags in the vector. It will be appreciated how the same search logic applies in identifying professionals, either members or advertisers, associated with one or more primary tags.

### G. User Interfaces and System Operations

FIG. 12A shows a graphical interface in the system of the invention used in identifying Legal Propositions and their associated tags related to a user word query. This interface corresponds roughly to that in the www.lexcites.com site and includes a query box for entering a word query, choices for selection of jurisdictions, and various command buttons. In the particular interface shown, the user has entered the word query “voting rights state primaries election discrimination,” and selected the US Supreme Court as the jurisdiction for cases from which tagged statements are searched. After entering the word query, clicking on “Enter query” will bring up the non-generic “Key Words” in the query. For each of these words, the user can adjust the weight of a word by clicking on the menu for that word, and selecting one of the four menu choices, as shown in dotted lines for the Key Word “voting.” The word-weight selection will assign a coefficient weight to the word-search vector, either 1 (default), 5 (emphasize), 50 (require) or 0 (discard).

Clicking on Search initiates the search for propositions that match the word query, and these are presented in the interface shown in FIG. 12B under Statements and Citations. The propositions and citations shown in the interface are the actual top-four ranked statements and cites obtained form the above word query, with all of the word weights kept at “default.” The contextual ads shown at the top above represent contextual ads that are identified by the method of the invention, using primary tags identified from the search query to generate a secondary-tag search vector, as detailed above, and searching a tag-ID table to identify top-ranked advertisers.

From the interface shown in FIG. 12B, the user can click on a selected citation link to see all other statements having that same citation, as shown in FIG. 12C. In the example illustrated, the user has clicked on the link to the cite “United States v. Classis, 313 U.S. 299,” and the program displays all statements associated with that cite in FIG. 12C, i.e., all statements from tagged statements extracted from the collection of Supreme Court cases that include that citation. These statements may be from the same case, but typically are from several cases, and present a rough summary of what the citation stands for in terms of legal propositions. The contextual ads shown at the top above are intended to represent contextual ads that are identified by the method of the invention, using the clicked-on citation as a primary tag, in constructing a secondary-tag search vector for identifying advertisers, in accordance with the method.

With continued reference to FIG. 12B, the user may also call up cases related to one or more citations from the Statements and Citations list, by checking the box beside each citation that appears relevant to the legal issue(s) of interest. Once the one or more boxes are checked, the program uses these citations as primary tags in constructing a second-tag search vector. By clicking on “Find case related to [symbol] ” the program will search the tag-ID table for Supreme Court cases that give highest match scores with the secondary-tag search vector, as discussed in the section above. A typical output display might look like the one in FIG. 12D, presenting a list of top-ranked cases. The Contextual Ads shown are those generated using the same secondary-tag search vector to find top-ranked advertisers in the tag-ID table.

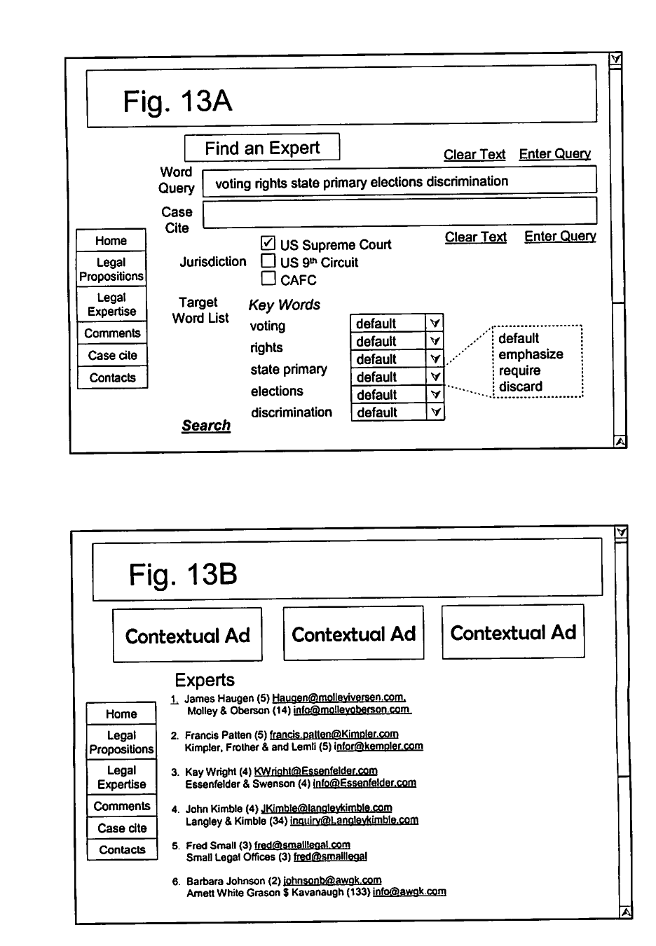

To find a professional with expertise in a given area, the user would click on “Legal Expertise” at the home page, and advance to the interface shown in FIG. 13A. As above, this interface is intended for the legal field but its principles and operation are applicable to other professional fields, as will be appreciated. As seen from the figure, the user can express the nature of the expertise being sought in one of two ways: either by a word query representing a proposition or statement related to the expertise, or a citation (case cite) for a case or article pertinent to the area of expertise being sought. For the word query illustrated, the program will find the most pertinent proposition and corresponding citations for the selected jurisdiction and word-weight choices. However, rather than present the top-ranked propositions and citations to the user, the program may simply take the top N, e.g., 5-10, citations from the word-query search, and employ these as primary tags in constructing a secondary-tag search vector. Alternatively, a single citation entered in the Case Cite box in the FIG. 13A can be used by the system as a single primary tag in constructing a secondary-tag search vector.

In either case, the program employs the secondary-tag search vector to identify from the tag-ID table, those professionals or advertisers whose associated tags give the top match scores for the secondary-tag search vector, and then uses the members and advertisers ID tables, respectively, to identify top-ranked professionals and advertisers to display to the user, as shown in the FIG. 13B interface. As noted above, the top-ranked professionals or advertisers may be further screened for locale, so that only top-ranked matches that also match the user's locale are presented.

From the forgoing, it will be appreciated how various objects and features of the invention are met. The method allows a user to identify pertinent citation-rich documents or pertinent professional expertise, based on linking tags retrieved from a user query to tags associated with the documents and professionals. In particular, the secondary-tag search method of the invention allows for the documents or professionals to be identified based on a large number of indirect tag connections, thus insuring that documents or professionals will be found on the basis of a rich network of connections among citation tags within a library of citation-rich documents. The same advantages apply to the method for displaying contextual ads in response to primary tags retrieved from a user input.

While the invention has been described with respect to particular embodiments and applications, it will be appreciated that various changes and modification may be made without departing from the spirit of the invention.

It is claimed:

1. A computer-assisted method for matching one or more citation tags with citation-rich documents or with professionals who are associated with a group of citation tags, comprising
(a) receiving an input from a user that contains or can be converted to contain one or more primary search tags,
(b) accessing a matrix of pair-wise tag co-occurrence values that are related to the co-occurrence of each pair of tags extracted from documents contained in a collection of citation-rich documents, to identify, for each primary tag received in step (a) those secondary tags whose pair-wise co-occurrence values with respect to the primary tag is above a selected threshold value,
(c) constructing a tag search vector containing, as vector terms, a plurality of the secondary tags identified in step (b), where the vector term coefficients for the secondary tags are related to their pair-wise co-occurrence values with respect to the associated primary tag,
(d) accessing a database that links citation tags to citation-rich documents or to professionals, thereby to identify those documents or professionals having the highest tag-matching score with respect to the tag search vector, and
(e) displaying to the user, information about one or more of the documents or professionals identified in step (d).

2. The method of claim 1, wherein step (c) includes constructing a tag search vector containing, as vector terms, for each such primary tag, those secondary tags whose pair-wise co-occurrence values with respect to the primary tag is above a selected threshold value.

3. The method of claim 2, wherein step (c) includes constructing a tag search vector containing, as vector terms, one or more of the primary tags received in step (a) and for each primary tag, those secondary tags whose pair-wise co-occurrence values with respect to the primary tag is above a selected threshold value.

4. The method of claim 1, wherein the matrix accessed in step (b) contains as its pair-wise tag co-occurrence values for any two tags, the ratio of number of documents containing both tags to the total number of documents containing either tag.

5. The method of claim 1, wherein the matrix accessed in step (b) contains as its pair-wise tag co-occurrence values for any two tags, the conditional probability of finding one of the two tags, given the other of the two tags.

6. The method of claim 5, wherein the sum of the pair-wise co-occurrence values in each row of the matrix have been normalized to 1.

7. The method of claim 1, wherein the user input is a statement or group of words representing a concept, and step (a) includes (a1) accessing a database containing phrases that represent summary holdings, statements, or conclusions contained in the collection of citation-rich documents, and for each such phrase, a tag representing the citation associated with that phrase in a citation-rich document, (a2) searching said database to identify one or more phrases that correspond to the user-input query, and (a3) accessing the database to link each of the one or more phrases identified in (a2) to associated citation tag(s) in said database.

8. The method of claim 7, wherein step (a) includes presenting to the user, word-weight choices that allow the user to select the coefficient that is assigned to each word in the query.

9. The method of claim 1, wherein the user input is one or more citation-rich documents, and step (a) includes processing the documents to extract citation tags therefrom, where the citation-rich documents are selected from the group consisting of published case law, legal briefs and opinions, and scholarly journal articles, and step (c) includes accessing the database that links citation tags to citation-rich documents.

10. The method of claim 1, for use in identifying professionals whose expertise match the one or more input primary search tags, wherein step (d) includes accessing a database that links citation tags to professionals, thereby to identify those professionals having the highest tag-matching score with respect to the tag search vector, and step (e) includes displaying to the user, information about one or more of the professionals identified in step (d).

11. The method of claim 1, for use in contextual advertising of professional services that match the one or more input primary search tags, wherein step (d) includes accessing a database that links citation tags to advertisements for services for professionals, thereby to identify those advertisements having the highest tag-matching score with respect to the tag search vector, and step (e) includes displaying to the user, one or more advertisements identified in step (d).

12. The method of claim 1, for use in identifying citation-rich documents that match the one or more input primary search tags, wherein step (d) includes accessing a database that links citation tags to citation-rich documents, thereby to identify those documents having the highest tag-matching score with respect to the tag search vector, and step (e) includes displaying to the user, one or more documents identified in step (d).

13. The method of claim 1, for use in identifying, promoting, or grouping one or more legal professionals having expertise with a given legal problem of interest, wherein the citation-rich documents are selected from appellate court decisions, legal briefs and memo, and law-review articles.

14. The method of claim 1, for use in identifying, promoting, or grouping one or more medical professionals having expertise with a given medical problem of interest, wherein the citation-rich documents include medical journal articles.

15. For use in matching one or more citation tags with citation-rich documents or with professionals who are associated with a group of citation tags, machine-readable code which is operable on a computer to execute machine-readable instructions for performing the steps comprising:
(a) receiving an input from a user that contains or can be converted to contain one or more primary search tags,
(b) accessing a matrix of pair-wise tag co-occurrence values that are related to the co-occurrence of each pair of tags extracted from documents contained in a collection of citation-rich documents, to identify, for each primary tag received in step (a) those secondary tags whose pair-wise co-occurrence values with respect to the primary tag is above a selected threshold value,
(c) constructing a tag search vector containing, as vector terms, a plurality of the secondary tags identified in step (b), where the vector term coefficients for secondary tags are related to their pair-wise co-occurrence values with respect to the associated primary tag,
(d) accessing a database that links citation tags to citation-rich documents or to professionals, thereby to identify those documents or professionals having the highest tag-matching score with respect to the tag search vector, and
(e) displaying to the user, information about one or more of the documents or professionals identified in step (d).

16. A website-based system for matching one or more citation tags with citation-rich documents or with professionals who are associated with a group of citation tags, comprising
(1) a website server accessible by user computer terminals, and
(2) machine-readable code which is operable on the server to execute machine-readable instructions for performing the steps comprising:
(a) receiving an input from a user that contains or can be converted to contain one or more primary search tags,
(b) accessing a matrix of pair-wise tag co-occurrence values that are related to the co-occurrence of each pair of tags extracted from documents contained in a collection of citation-rich documents, to identify, for each primary tag received in step (a) those secondary tags whose pair-wise co-occurrence values with respect to the primary tag is above a selected threshold value,
(c) constructing a tag search vector containing, as vector terms, a plurality of the secondary tags identified in step (b), where the vector term coefficients for secondary tags are related to their pair-wise co-occurrence values with respect to the associated primary tag,
(d) accessing a database that links citation tags to citation-rich documents or to professionals, thereby to identify those documents or professionals having the highest tag-matching score with respect to the tag search vector, and
(e) displaying to the user, information about one or more of the documents or professionals identified in step (d).
